(19) United States
(12) Patent Application Publication
(10) Pub. No.: US 2019/0213559 A1
(43) Pub. Date: Jul. 11, 2019

(54) Web-based appointment scheduling system, and method

(71) Applicant: Dario Edel Beltran, Stafford, VA (US)

(72) Inventor: Dario Edel Beltran, Stafford, VA (US)

(21) Appl. No.: 16/350,505

(22) Filed: Nov. 26, 2018

Related U.S. Application Data
(60) Provisional application No. 62/709,170, filed on Jan. 10, 2018.

(51) Int. Cl. G06Q 10/10; G06F 16/9538; G06F 3/0482

(52) U.S. Cl. CPC G06Q 10/1095; G06F 3/0482; G06F 16/9538

(57) ABSTRACT

A vehicle appointment scheduling method allowing a user to schedule an appointment by clicking on a logo or link next to a vehicle of interest on a Vehicle Display Page (VDP) to arrangement an appointment with a vehicle dealership.

### RELATED APPLICATION

This application claims the benefit of U.S. Provisional Application No. 62/709,170, filed Jan. 10, 2018, which is incorporated by reference in its entirety.

### FIELD

A web-based appointment scheduling (i.e. setting) system and method for allowing a user to go online to a website and arrange an appointment with a business entity such as a vehicle dealership, retailer, professional firm, or other business. For example, the web-based appointment scheduling system is for making sales and/or service appointments with automobile/truck dealerships.

### BACKGROUND

Currently, a user can arrange an appointment at a business by calling the business via telephone and talking with an operator, assistant, or other appropriate personnel to make an appointment. For example, a person interested in purchasing a vehicle or making a vehicle service appointment can call a vehicle dealership and make an appointment with the vehicle dealership for purchasing a vehicle or making a vehicle service appointment. The appointment can be entered into computer based appointment software at the dealership for collecting contact information, and then selecting a time and date for the appointment at the vehicle dealership. This manner of making a sales or service appointment at the vehicle dealership may be inconvenient due to call waiting, call rerouting, personnel unavailable, appointment time and/or date not available, and other factors that can make this manner of making an appointment inconvenient and/or ineffective. Alternatively, a user can go onto a dealership's website and make an appointment for sales or service by finding an appointment button or link, entering contact information, and then selecting a time and date for the appointment at the dealership. This manner of making a sales or service appointment may be inconvenient due to unfamiliarity with the particular vehicle dealership's website, which is not standardized and instead typically customized by the particular vehicle dealership website designer.

Further, currently vehicle dealerships are now purchasing, for a very high premium, leads from multiple lead sources. These leads are commonly incomplete, and missing key information. The ratio of appointments set to sales is low in regards to the amount of leads that are received. This type of service comes at a cost to the consumer, usually with membership to certain clubs or agencies. The customer information is shared with multiple dealerships, and the customers are then contacted repeatedly, in an effort to schedule an actual appointment.

There exists a need for a more convenient streamlined system and method for a user to make appointments according to the present invention.

Further, there exists a need to be able to deliver complete sets of sorted local buyers to vehicle dealerships for a monthly fee.

### SUMMARY

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the website selects the vehicle dealership for the user.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the website selects the closest vehicle dealership located to the user based on the zip code of the user and the zip code of the vehicle dealership.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the website selects the closest vehicle dealership located to the user based on the address of the user and the address of the vehicle dealership.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the website displays to the user online a listing of multiple vehicle dealerships that can be selected by the user.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the website displays to the user online a listing of multiple vehicle dealerships that can be selected by the user, and wherein the website displays to the user online a distance between the user's address and each of the multiple vehicle dealerships.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the confirmation is communicated via email to the user and the vehicle dealership.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the confirmation is communicated via text message to the user and the vehicle dealership.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the contact information comprises only the user's name and user's email address.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the contact information, optionally, includes the user's telephone number.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, further comprising entering the year of the user's vehicle.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the appointment is a sales appointment.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the appointment is a sales appointment for scheduling a test drive of a vehicle selected by the user.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the appointment is a service appointment for the user's vehicle.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the appointment is a service appointment for the user's vehicle, wherein the user enters comments regarding the servicing of the user's vehicle.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the appointment is a service appointment for the user's vehicle, wherein the user enters comments regarding the servicing of the user's vehicle, wherein the servicing includes one or more selected from the group consisting of vehicle inspection, oil change, tire rotation, vehicle repair, and vehicle maintenance.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the user accesses the website by clicking on a link displayed on a dealership inventory vehicle display page (VDP) on a dealer's website.

The presently described subject matter is directed to a web-based vehicle dealership appointment scheduling method comprising or consisting of a user accessing a website for scheduling an appointment; the user entering vehicle information regarding the make and model of a vehicle; the user entering contact information regarding the user; the user selecting a date for the appointment; the user selecting a time for the appointment; selecting an appointment with a vehicle dealership based on a proximity of the user to the proximity of the vehicle dealership; and communicating a confirmation of a scheduled appointment to the user and the vehicle dealership, wherein the user accesses the website by clicking on a link displayed on a dealership inventory vehicle display page (VDP) on a dealer's website, wherein the link is a displayed logo functioning as a link.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein the user initially enters a vehicle information regarding the make and model of the vehicle of interest on the vehicle dealership website.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein alternatively the user can go directly onto the vehicle appointment scheduling website and view vehicle inventory from multiple vehicle dealerships.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein an operator of the vehicle appointment website selects the vehicle dealerships available on the vehicle appointment scheduling website.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein vehicle dealerships are selected by an operator of the vehicle appointment scheduling website based on at least one range of distance from a central location of the user.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein vehicle dealerships are selected by an operator of the vehicle appointment scheduling website based on the vehicle dealerships having a membership or affiliation with the vehicle appointment website.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein alternatively the user can go directly onto the vehicle appointment scheduling website and view vehicle inventory from multiple vehicle dealerships, wherein vehicle dealerships are selected by an operator of the vehicle appointment scheduling website based on a varying fee schedule dictating priority.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein the user enters contact information into the vehicle appointment scheduling website to arrange an appointment with the vehicle dealership.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein the user enters contact information into the vehicle appointment scheduling website to arrange an appointment with the vehicle dealership, wherein the user selects an available time and date for the appointment with the vehicle dealership through the vehicle appointment scheduling website.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein the user receives a confirmation from the vehicle appointment scheduling website after making an appointment with the vehicle dealership.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein the user receives a confirmation from the vehicle appointment scheduling website after making an appointment with the vehicle dealership, and wherein the vehicle dealership selected by the user clicking on the vehicle appointment scheduling website next to the vehicle of interest receives a confirmation from the vehicle appointment scheduling website.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein the vehicle appointment scheduling website receives information on available times and dates for sales appointments from participating vehicle dealerships.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein the vehicle appointment scheduling website receives information on available times and dates for sales appointments from participating vehicle dealerships, and wherein the available times and dates are updated continuously in real time between the participating vehicle dealership websites and the vehicle appointment scheduling website.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein alternatively the user can go directly onto the vehicle appointment scheduling website and view vehicle inventory from multiple vehicle dealerships, and wherein the vehicle appointment scheduling website selects the closest vehicle dealerships located to the user based on the zip code of the user and the zip code of the vehicle dealerships.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein alternatively the user can go directly onto the vehicle appointment scheduling website and view vehicle inventory from multiple vehicle dealership, and wherein the vehicle appointment scheduling website selects the closest vehicle dealerships located to the user based on the address of the user and the address of the vehicle dealerships.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein alternatively the user can go directly onto the vehicle appointment scheduling website and view vehicle inventory from multiple vehicle dealerships, and wherein the vehicle appointment scheduling website displays to the user online a listing of multiple vehicle dealerships that can be selected by the user.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein alternatively the user can go directly onto the vehicle appointment scheduling website and view vehicle inventory from multiple vehicle dealership, and wherein the vehicle appointment scheduling website displays to the user online a distance between the user's address and each of the multiple vehicle dealerships.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein alternatively the user can go directly onto the vehicle appointment scheduling website and view vehicle inventory from multiple vehicle dealerships, and wherein the user clicks the vehicle appointment scheduling website logo or link next to the vehicle of interest to make an appointment with the vehicle dealership having the vehicle of interest at the location of the vehicle dealership.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein alternatively the user can go directly onto the vehicle appointment scheduling website and view vehicle inventory from multiple vehicle dealerships, and wherein the user clicks the vehicle appointment scheduling website logo or link next to the vehicle of interest to make an appointment with the vehicle dealership having the vehicle of interest at the location of the vehicle dealership, and wherein the user enters comments regarding the servicing of the user's vehicle.

The presently described subject matter is directed to a web-based vehicle dealership appointment scheduling method comprising or consisting of: a user accessing a vehicle dealership website for viewing vehicles on a Vehicle Display Page (VDP); the user selecting a vehicle of interest by clicking on an appointment scheduling website logo or link next the vehicle of interest; redirecting the user from the vehicle dealership website to the appointment scheduling website; and scheduling an appointment with the vehicle dealership website using the vehicle appointment scheduling website, wherein alternatively the user can go directly onto the vehicle appointment scheduling website and view vehicle inventory from multiple vehicle dealerships, and wherein the user clicks the vehicle appointment scheduling website logo or link next to the vehicle of interest to make an appointment with the vehicle dealership having the vehicle of interest at the location of the vehicle dealership, and wherein the user enters comments regarding the servicing of the user's vehicle, wherein the servicing includes one or more selected from the group consisting of vehicle inspection, oil change, tire rotation, vehicle repair, and vehicle maintenance.

The present invention is directed to a website-based system and method for allowing a user to go online to a website and make an appointment. For example, the user goes onto the website and then enters information, including a desired vehicle and contact information, and then selects a date and time for the appointment. For example, based on the user's address and/or zip code, the program selects the closest business (e.g. vehicle dealership) to make the appointment, and then the user selects a date on a calendar and a time slot on a time schedule to schedule the appointment. For example, a current month calendar is displayed on the user's screen, and the user clicks on an open date. Then available time slots are displayed on the user's screen, and the user clicks on a time slot. Alternatively, a list of local vehicle dealerships can be displayed (e.g. list of five (5) closest business or car dealerships), and then the user can click on the name of a particular vehicle dealership to select the particular dealership to make the appointment.

After making the appointment, the website can confirm and display the appointment on the user's screen (e.g. appointment number, business name, date, time, and type of appointment). The user can save and/or print the displayed confirmation from their screen. Further, alternatively or in addition, the website can send the user a text and/or email confirming the appointment For example, the website can text a confirmation of the appointment to the user's cell phone, or email a confirmation to the user's personal computer, laptop, cell phone, or personal digital device. Further, as the appointment time gets close in time (e.g. day before and/or same day prior as the appointment), the user can again be sent a reminder via text confirmation and/or email confirmation.

The website is configured to make it as convenient and friendly to use as possible for the user (e.g. logical display, simplified display arrangement, self-directing, minimized number of clicks to complete and confirm appointment, and standardized format and operation). Further, as the same website is repeatedly used by the user this allows the user to become familiar with the website's format, operation, and use to enhance the user's convenience, comfort, and familiarity with the website.

For example, the website is designed or configured for making a purchase or sales appointment with a new and/or used vehicle dealership and/or for making vehicle service appointments (e.g. inspections, evaluations, trouble shooting, maintenance, and/or repairs).

The website comprises a trade name and web address, for example, CARSETTER (www.carsetter.com), which can be a convenient digital platform that allows automotive customers (i.e. users) the ability to schedule appointments for vehicle purchases/sales and/or vehicle service using their personal computer, laptop, cell phone, pad, or other personal digital device with the click of a few buttons. For example, in 30 seconds or less, the user can arrange their appointment with one or more brands (e.g. up to 3 different brands). The user can select the time and date that is desired by the user, and then the user's appointment will be set up with a local dealership. The website requires no address, and is convenient and friendly to use. The website can be free to the user to arrange vehicle appointments.

The website can be configured or arranged to generate multiple potential revenue streams. For example, the website is a convenient, complimentary appointment setter for vehicle shoppers generating vehicle sales revenue and/or services revenue for dealership owners. As another example, the website is a revenue generating business that sells scheduled and confirmed appointments to the vehicle dealerships.

The present system comprises a website (e.g. CARSETTER website). The website can be accessed by a computer or accessed using a mobile application (i.e. mobile app) to provide further convenience for the user.

The website can consist of the company's logo (e.g. approximately 6 inches) across the front page. The website page can be in landscape format. The mobile app can scale to fit or use vertical format. The particular shape, size, and font style for the website can be selected by the website designer. The finalized company logo is also to be determined.

The website, for example, can include multiple sections or pages for entering information by the user into the website, including:
1) vehicle information—the vehicle information for new cars can be the make and model and for used cars can be the year, make, and model;
2) contact information—the contact information for the user can be the user's full name, email address, phone number, and zip code;
3) date information—the date information for the appointment can be selected by the user on a monthly calendar;
4) time information—the time information for the appointment can be selected by the user on a time schedule; and
5) social media information—sharing the social media information for the appointment can be selected by the user on a social media platform.

The website, for example, can include multiple selection boxes for entering specific information by the user into the website, including:
1) year of vehicle—the user can enter the year for a new vehicle or used vehicle;
2) make of vehicle—the user can enter the make for the new vehicle or used vehicle;
3) model of vehicle—the user can enter the model for the new vehicle or used vehicle;
4) full name—the user can enter the full name of the user;
5) email address—the user can enter their email address;
6) phone number—the user can enter their phone number;
7) zip code—the user can enter their zip code (e.g. residence or business);
8) date—the user can select an appointment date from the calendar;
9) time—the user can select an appointment time from the time schedule; and
10) social media platform—the user can select their social media platform preference from the social media platform schedule.

The website can include one or more appointment buttons on which the user can click to arrange and finalize the appointment. The button can state “Make Sales Appointment”, “Schedule Test Drive”, or “Make Service Appointment.”

Further, the website includes a calendar. For example, the calendar can be provided in the bottom right hand portion of the webpage (e.g. 2.5 inches in from the margin). Again, the calendar can be used by the user to select a date for the appointment. For example, the next day provides the first available time slot and the user can schedule the appointment up to ten (10) days out. The month will update automatically and appointments on Outlook will also automatically update. The time schedule (e.g. a scroll up/down feature) allows the user to schedule the time slot for the user's appointment. For example, time slots for a particular date can be set in 30-minute intervals. Further, for example, at the bottom left (e.g. 2.5 inches in from margins) of the web page there can be a drop down selection box (e.g. 3 inch×3 inch box) with all the different automotive manufacturers listed. Artwork can be provided to fit the rest of the website section or page to add visual aid.

The information gathered by the website plays a critical role. How the information is sorted, and applied to different algorithms created for bundling is essential. For example, the information enter by the user and gathered by the website (e.g. website database) can be bundled together based on zip code. This means that the information will be paired up with the zip code location. The location activated will push out and pair with the information with the local vehicle dealership. The vehicle dealership can be looked up in a directory based on the zip code. The information will sort itself by name, zip code, and local vehicle dealership. That will be the initial bundle step that takes place. This information sequence shall be repeated by location across all the zip codes. Essentially every zip code that contains a dealership will be available.

When the customer's zip code is entered by the user, or alternatively automatically detected, it will tie up and pair with the local vehicle dealership for that entity. Considering the brand selected, and the proximity of that brand to that specific location, the nearest vehicle dealership will come up. This information will be transmitted to a portal where it will be available. This will be the bundled information that will be sold to the individual dealership and set appointments.

Again, CARSETTER is an online website and/or mobile application that allows consumers (i.e. users) to conveniently schedule their sales appointments with their local dealerships fast and free. The tool has been developed to schedule the “sales” appointments for the dealership. The online website can also include the “service” end of the vehicle dealership as well. For example, the website and/or mobile app can be used to conveniently schedule vehicle dealership service appointments. Service appointments are scheduled more often, and at a higher rate than the sales appointments. Further, service intervals occur much closer together in time (every 6 months) verses the normal sales cycle (2-3 years). This addition in functionality of the website can also create more traffic and substance to the website and its operation, all while providing the user an efficient, convenient way to schedule their appointments, and also allocate the local customers back to the local dealership. The addition of this function can be generated as follows:

The website can be designed or configured to offer the user the choice of “SALES” or “SERVICE” on the home page (e.g. button for sales and button for service. After the user makes their choice, the website will direct them to the necessary data points to gather the information and schedule the appointment. Nothing pertaining to the list of functions and explanation of functions for scheduling the sales appointment will change. That process will stay the same, from gathering the information, to pairing the information, to distributing the information. The only change will be that the “sales appointment layout” will no longer be the first thing the user encounters when going to the website, but rather displayed when the “sales button” is selected. When the “service button” is selected, this is where the additional functionality and visual interpretation will be displayed, and will be added to the website.

For example, the user can select the service button which will route them to the service interface. Much like the sales interface, the service interface will be separate sections or pages for the user to enter the information and the website to gather the information needed to schedule the appointment. The first section will be the “Year”, “Make”, and “Model” of the vehicle needing service. The second section can have multiple boxes to gather information. The site will require a name, email address, zip code, and phone number. The phone number will act as a confirmation tool, but also give the dealership the ability to accommodate the demand, and work flow by contacting the customers if need be. This feature is not required (i.e. optional) when scheduling a sales appointment with the website. Text and/or email confirmations will also be available from the website. There can also be a description box in this section of the interface which allows the user to quickly describe why the vehicles needs a service appointment (i.e. state inspection, oil change, tire rotation, 30 k service, vehicle problem or issue). A section or page can have a calendar, and clock, to schedule the day and time of the requested appointment. For example, the time frames can range from 7 am-7 pm, and at 15-minute intervals. Like the sales feature, the service feature will allow the user to schedule their service appointments, for example, up to 30 days out.

Once the service appointment is scheduled, the process of collecting the data and bundling the information will be the same as the sales appointment process. The distribution of this information will also be distributed exactly like the sales appointment information.

### BRIEF DESCRIPTION OF DRAWINGS

FIG. 1 represents a schematic diagram illustrating the appointment scheduling system.

FIG. 2 is a screen shot showing the home page of a website having a SALES APPOINTMENT button and a SERVICE APPOINTMENT button.

FIG. 3 is a screen shot showing a VEHICLE INFORMATION section or web page of the website after clicking the SALES APPOINTMENT button in FIG. 2 allowing the user to enter the make and model of a vehicle the user in interested in purchasing.

FIG. 4 is a screen shot showing the selection box for selecting a vehicle make in the VEHICLE INFORMATION section or web page shown in FIG. 3.

FIG. 5 is a screen shot showing the selection box for selecting the vehicle model in the VEHICLE INFORMATION section or web page shown in FIG. 3.

FIG. 6 is a screen shot showing the selection box for selecting the vehicle make and model not listed in the above selection boxes in the VEHICLE INFORMATION section or web page shown in FIG. 3.

FIG. 7 is a screen shot showing the CONTACT INFORMATION section or web page of the website allowing a user to enter personal contact information to schedule a sales appointment.

FIG. 8 is a screen shot showing the selection box for entering the FULL NAME of the user in the CONTACT INFORMATION section or web page shown in FIG. 7.

FIG. 9 is a screen shot showing the selection box for entering the EMAIL address of the user in the CONTACT INFORMATION section or web page shown in FIG. 7.

FIG. 10 is a screen shot showing the selection box for entering the PHONE number of the user in the CONTACT INFORMATION section or web page shown in FIG. 7.

FIG. 11 is a screen shot showing the selection box for entering the ZIPCODE of the user in the CONTACT INFORMATION section or web page shown in FIG. 7.

FIG. 12 is a screen shot showing the SCHEDULE TEST DRIVE button in a section or web page of the website.

FIG. 13 is screen shot showing the CHOOSE DATE section or web page of the website after clicking the SCHEDULE TEST DRIVE button shown in FIG. 12.

FIG. 14 is a screen shot showing the CHOOSE DATE section or web page of the website allowing a user to select a date to schedule a sales appointment on a calendar in the CHOOSE DATE section or web page of the website.

FIG. 15 is a screen shot showing the selection box for selecting the month of a date on the calendar in the CHOOSE DATE section or page shown in FIG. 13.

FIG. 16 is a screen shot showing the time schedule allowing a user to select a time in a section or page of the website.

FIG. 17 is a screen shot showing a social media section or web page of the website allowing a user to select a social media website to create a link for sharing information.

FIG. 18 is a screen shot showing the VEHICLE INFORMATION section or web page of the website after clicking the SERVICE APPOINTMENT button shown in FIG. 2 allowing a user to enter the make and the model of the user's vehicle to be serviced.

FIG. 19 is a screen shot showing the selection box for selecting the user's vehicle make in the VEHICLE INFORMATION section or web page shown in FIG. 18.

FIG. 20 is a screen shot showing the selection box for selecting the user's vehicle model in the vehicle information section or web page shown in FIG. 18.

FIG. 21 is a screen shot showing the selection box for selecting a user's vehicle by make and mode not listed in the above selection boxes in the VEHICLE INFORMATION section or web page shown in FIG. 18.

FIG. 22 is a screen shot showing the selection box for adding Comments by the user regarding issues or service work to be conducted on the user's vehicle.

FIG. 23 is a screen shot showing the CONTACT INFORMATION section or web page of the website allowing a user to enter personal contact information to schedule a vehicle service appointment.

FIG. 24 is a screen shot showing the selection box for entering the users FULL NAME in the CONTACT INFORMATION section or web page shown in FIG. 23.

FIG. 25 is a screen shot showing the selection box for entering the EMAIL address in the CONTACT INFORMATION section or web page shown in FIG. 23.

FIG. 26 is a screen shot showing the selection box for entering the PHONE number in the CONTACT INFORMATION section or web page shown in FIG. 23.

FIG. 27 is a screen shot showing the selection box for entering the ZIPCODE of the user in the CONTACT INFORMATION section or web page shown in FIG. 23.

FIG. 28 is a screen shot showing a SCHEDULE SERVICE NOW button in a section or web page of the website.

FIG. 29 is a screen shot showing a CHOOSE DATE section or web page of the website after clicking on the SCHEDULE SERVICE NOW button shown in FIG. 28.

FIG. 30 is a screen shot in the CHOOSE DATE section or web page of the website allowing a user to select a date to schedule a service appointment on the user's vehicle.

FIG. 31 is a screen shot showing the selection box for selecting a date in the CHOOSE DATE section or web page shown in FIG. 29.

FIG. 32 is a screen shot showing a time schedule allowing a user to select a time for the service appointment on the user's vehicle.

FIG. 33 is a screen shot showing a social media section or web page of the website allowing a user to select a social media website to create a link for sharing information.

FIG. 34 is a screen shot showing a web page comprising a VEHICLE INFORMATION section, CONTACT INFORMATION section, and CHOOSE DATE section.

FIG. 35 is a screen shot showing a web page with SALES button and SERVICE button.

FIG. 36 is a screen shot showing the web page comprising a VEHICLE INFORMATION section, CONTACT INFORMATION section, CHOOSE DATE section, and a SCHEDULE TEST DRIVE button.

FIG. 37 is a block flow diagram illustrating a methodology for implementing the appointment scheduling system.

FIG. 38 is a screen shot showing a dealership webpage showing an inventory of vehicles for sale along with a symbol functioning as a link from the dealership website to the appointment scheduling website for scheduling a sales appointment for the vehicle selected in the dealership inventory by the user by clicking on the particular link shown next to the selected vehicle.

### DETAILED DESCRIPTION

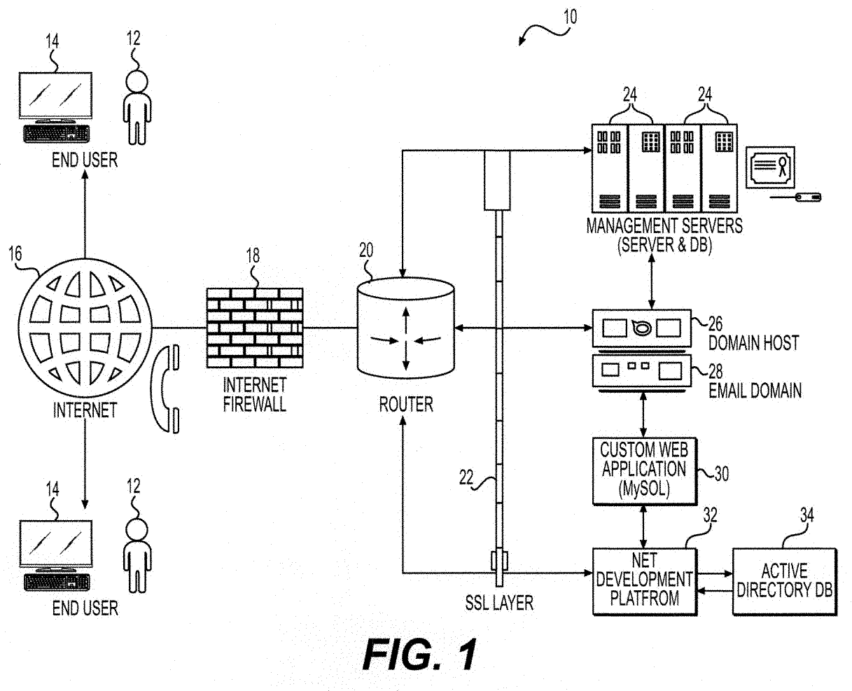

A web-based appointment scheduling system 10 according to the present invention is shown in FIG. 1. Multiple users 12 can connect to the website on their respective computers 14 (e.g. personal computer, laptops, phones, pads) via the Internet 16. Specifically, the users 12 connect via the Internet 16 to the website through an Internet firewall 18 to a website router 20. A secure sockets layer or SSL layer 22 is provided to provide standard security technology for establishing an encrypted link between the web server and browser. This link ensures that all data passed between the web server and browser(s) remain private and integral.

The website router 20 is connected to the management server and database 24, which are connected to the domain host server 26 and email domain server 28. The domain host server 26, for example, is provided for internet service that manages the website's domain name, CARSETTER™. The domain host uses DNS records to connect the domain name with email, websites, and other web services. An email domain server 28 is provided for handling the website's email.

The website can further include a custom web application 30, net development platform 32, and active directory database 34, as shown in FIG. 1.

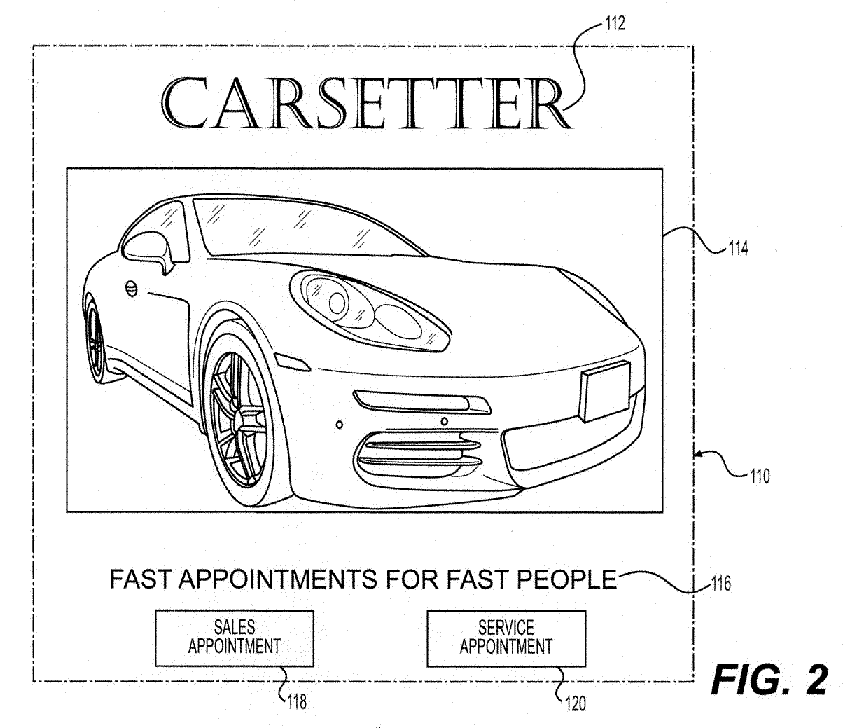

The CARSETTER™ website home page 110 is shown in FIG. 2. The home page 110 comprises the CARSETTER™ logo 112, marketing photo 114 (e.g. car photo), slogan 116, SALES APPOINTMENT button 118, and SERVICE APPOINTMENT button 120.

### Sales Appointments

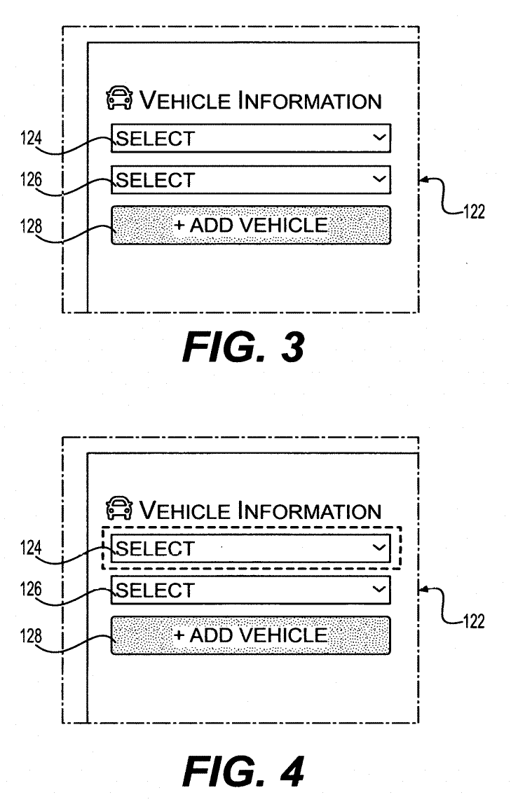

After clicking on the SALES APPOINTMENT button 118 in the home page 110 shown in FIG. 2, the VEHICLE INFORMATION section 122 is displayed, as shown in FIGS. 3-6. The VEHICLE INFORMATION section 122 comprises a vehicle MAKE selection box 124, vehicle MODEL selection box 126, and an ADD VEHICLE selection box 128. The website section 122 can be a section of a web page or a web page itself.

As shown in FIG. 4, the vehicle MAKE selection box 124 includes a drop down feature that includes all vehicle makes available for sale.

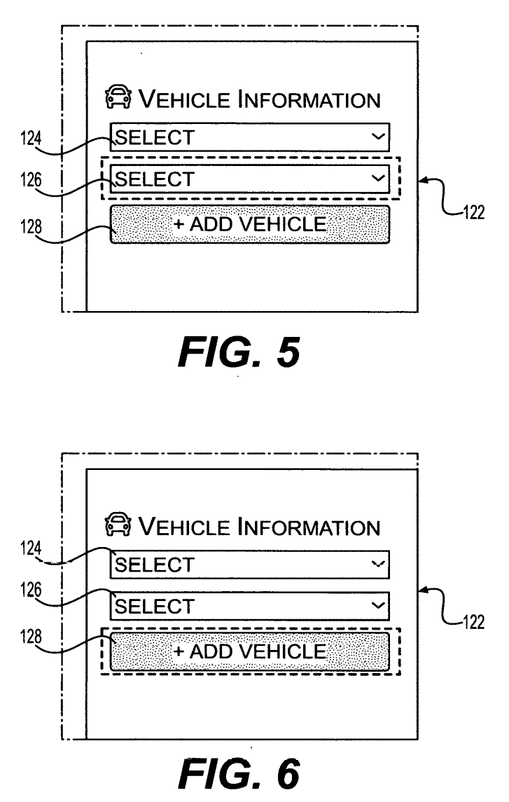

As shown in FIG. 5, the vehicle MODEL selection box 126 includes a drop down feature that includes all vehicle models that are available for sale.

As shown in FIG. 6, the ADD VEHICLE selection box 128 is used when a particular vehicle make or model is not found in selection boxes 124, 126, respectively. The user can then enter a vehicle that the user is interested in purchasing.

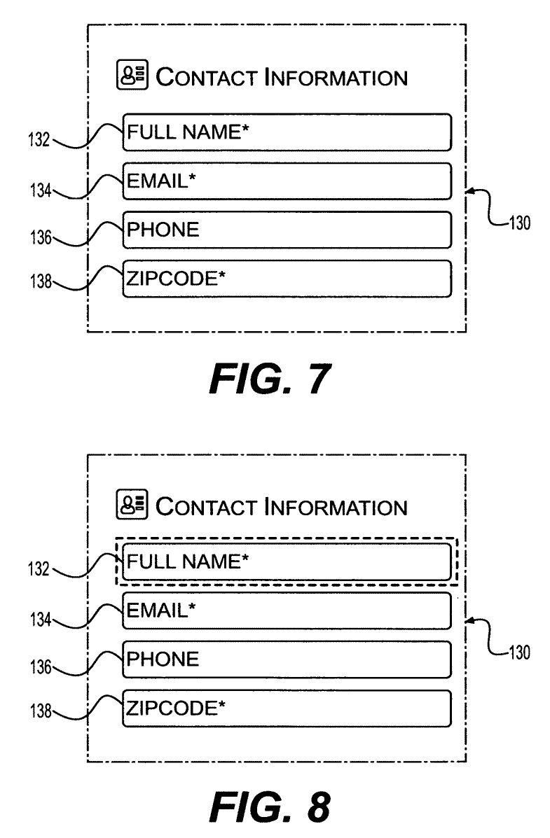

After completing the VEHICLE INFORMATION section 122, the user can then enter their contact information into the CONTACT INFORMATION section 130, as shown in FIGS. 7-11. The CONTACT INFORMATION section 130 comprises a user's FULL NAME selection box 132, a user's EMAIL selection box 134, a user's PHONE number selection box 136, and a ZIPCODE selection box 138.

As shown in FIG. 8, the user's FULL NAME selection box 132 is mandatory and must be filled in by the user to schedule a sales appointment. The FULL NAME selection box 132 requires the full name of the user to be entered. The site visitor can simply type in their name and move forward.

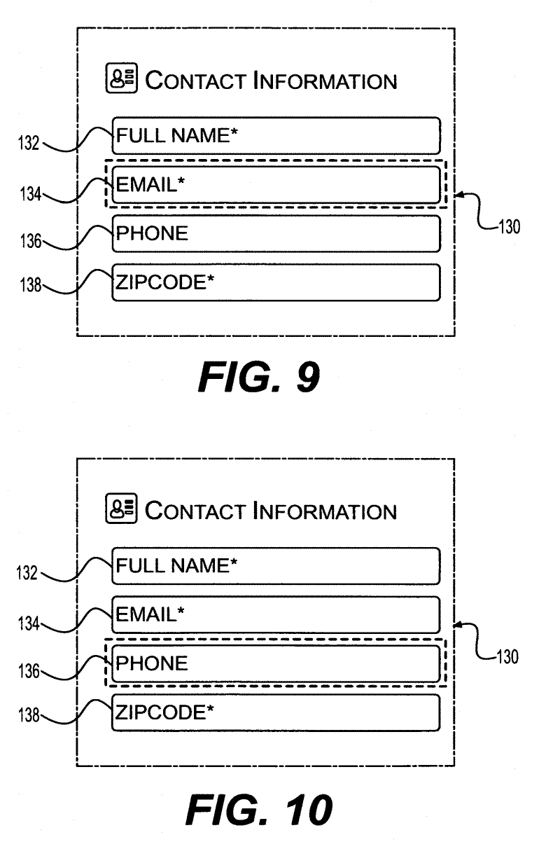

As shown in FIG. 9, the user's EMAIL selection box 134 is mandatory and must be filled in by the user to schedule a sales appointment. The EMAIL selection box 134 requires the valid email address of the user to be entered. The site visitor can simply type in their email address and move forward.

As shown in FIG. 10, the PHONE number selection box 136 is not mandatory, and is optionally filled in by the user to schedule a sales appointment. The PHONE number selection box 136 requires the phone number of the user to be entered. The site visitor can simply type in their digits.

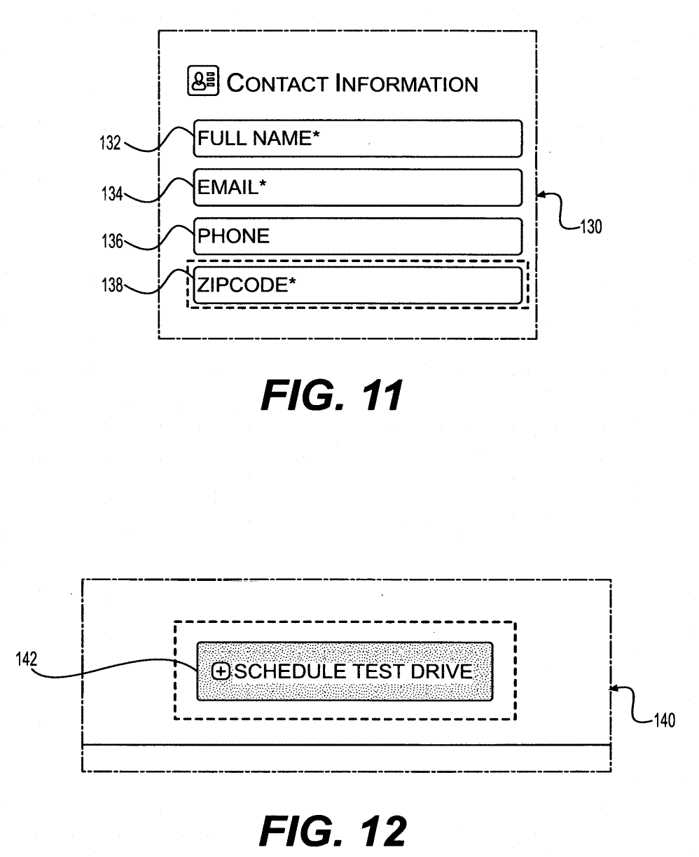

As shown in FIG. 11, the ZIPCODE selection box 138 is mandatory and must be fill out by the consumer to schedule a sales appointment. The ZIPCODE selection box 138 requires the zip code of the user to be entered. The site visitor can simply type in their zip code and move forward.

After completing the CONTACT INFORMATION section 130, the SCHEDULE TEST DRIVE button 142 is displayed in section 140, as shown in FIG. 12. Once all of the pertinent information is filled in by the user in the VEHICLE INFORMATION section 122 (FIG. 3) and the CONTACT INFORMATION section 130 (FIG. 7), then the SCHEDULE TEST DRIVE button 142 is clicked on by the user. A pop up will be displayed and inform the user that a confirmation email and/or text, if phone number entered, will be sent to the user's email provided. This step will schedule and finalize the user's sales appointment.

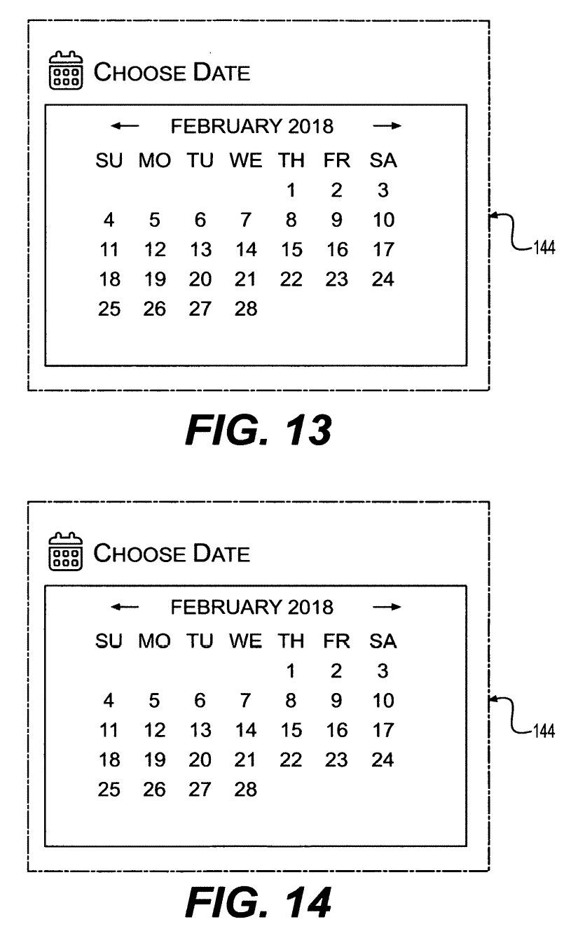

After clicking on the SCHEDULE TEST DRIVE button 142 and the confirmation is displayed, the CHOOSE DATE section 144 is then displayed, as shown in FIG. 13.

The CHOOSE DATE section 44 is shown in FIGS. 13-15. The CHOOSE DATE section 144 of the web page is where the user selects the specific date of their sales appointment.

As shown in FIG. 14, the CHOOSE DATE section 144 includes a calendar to allow the user to select the date user would like to schedule their sales appointment. The calendar lists the days, including Su (Sunday) thru Sa (Saturday) across the top of the days with the particular month corresponding to the date displayed above. The user can then select from all available dates for the particular date for their sales appointment.

As shown in FIG. 15, the MONTH selection box 146 allows the user the ability to select the current month, past, or future month to schedule their sales appointment in the calendar of the CHOOSE DATE section 144. The user's sales appointment, for example, can be selected up to 30 days in advance.

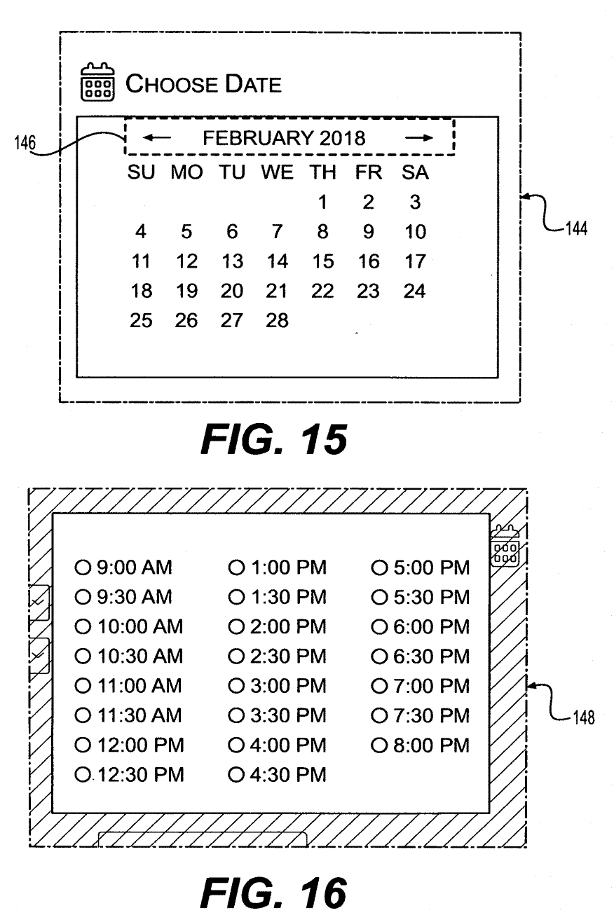

The TIME selection box 148 is shown in FIG. 16. The TIME selection box 148 pops up, for example, automatically after the user selects their date. The pop-up, for example, will display available time slots to be selected by the user. The time slots are available, for example, from 9:00 am-9:00 pm. The times slots, for example, will be in 30 minute intervals.

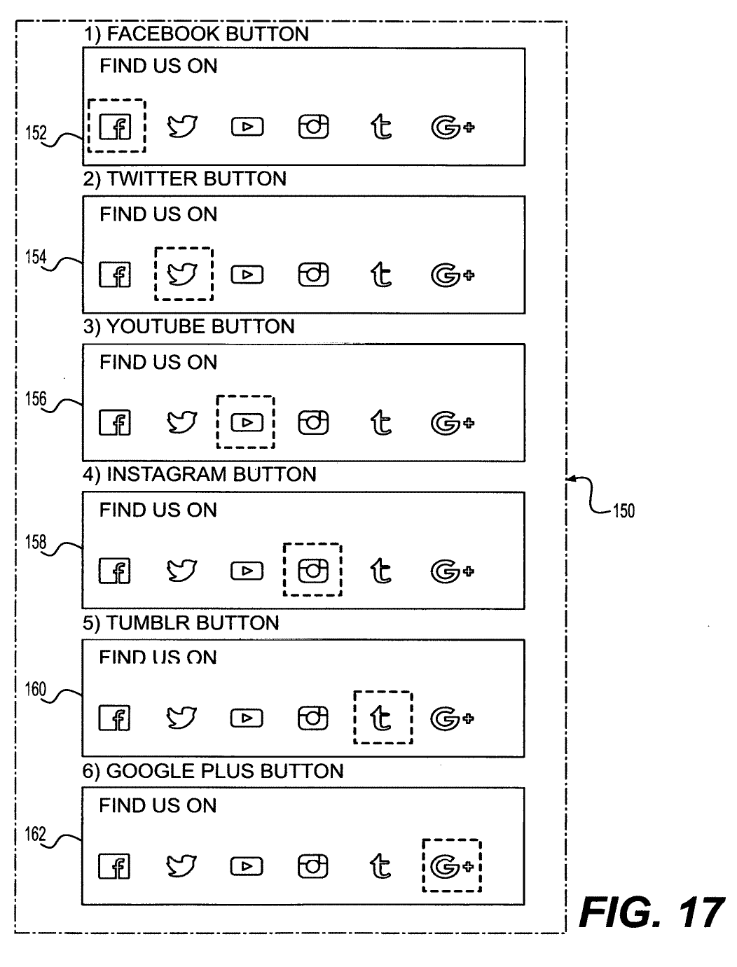

The Social Media Platform section 150 is shown in FIG. 17. This is the section of the webpage where the user can share the usage of this platform to Social Media. The Social Media Platform section 150 comprises a Facebook button 152, Twitter button 154, You Tube button 156, Instagram button 158, Tumblr button 160, and Google Plus button 162.

### Service Appointments

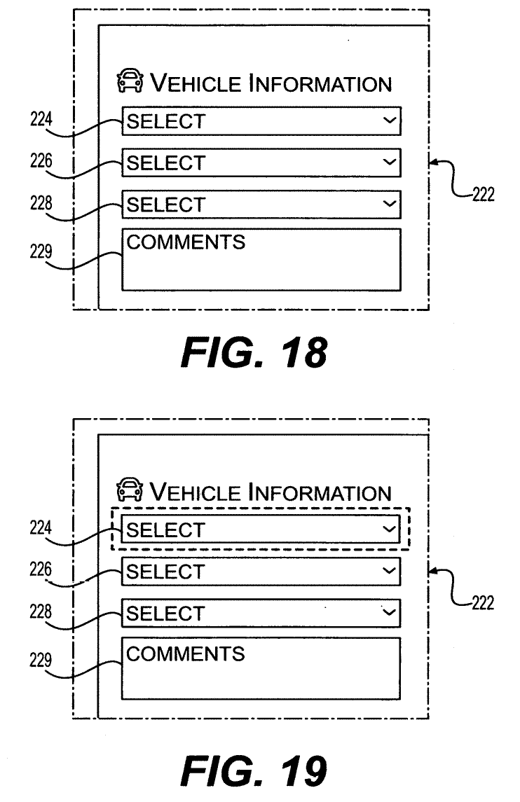

After clicking on the SERVICE APPOINTMENT button 120 in the home page 110 shown in FIG. 2, the VEHICLE INFORMATION section 222 is displayed, as shown in FIGS. 18-22. The VEHCILE INFORMATION section 222 comprises a vehicle MAKE selection box 224, vehicle MODEL selection box 226, an ADD VEHICLE selection box 228, and a COMMENTS selection box 229 The website section 222 can be a section of a web page or a web page itself.

As shown in FIG. 19, the vehicle MAKE selection box 224 includes a drop down feature that includes all vehicle makes available for sale.

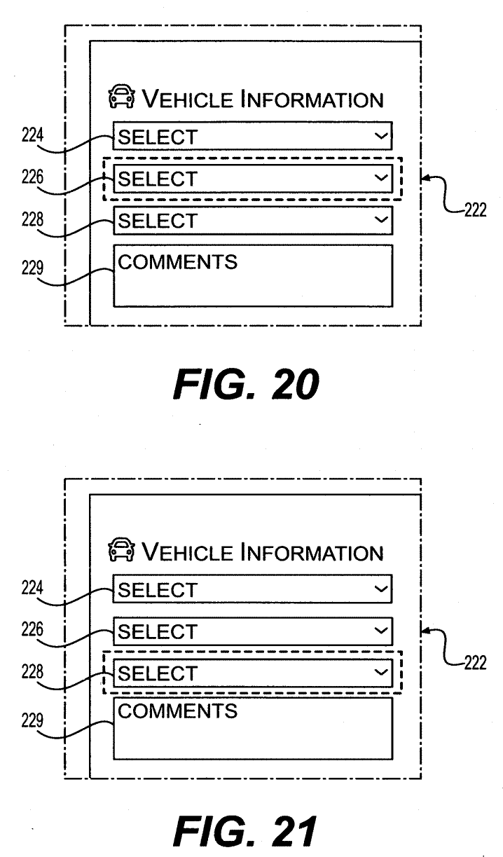

As shown in FIG. 20, the vehicle MODEL selection box 116 includes a drop down feature that includes all vehicle models that are available for sale.

As shown in FIG. 21, the ADD VEHICLE selection box 228 is used when a particular vehicle make or model is not found in selection boxes 124, 126, respectively. The user can then enter their vehicle that the user is interested in servicing.

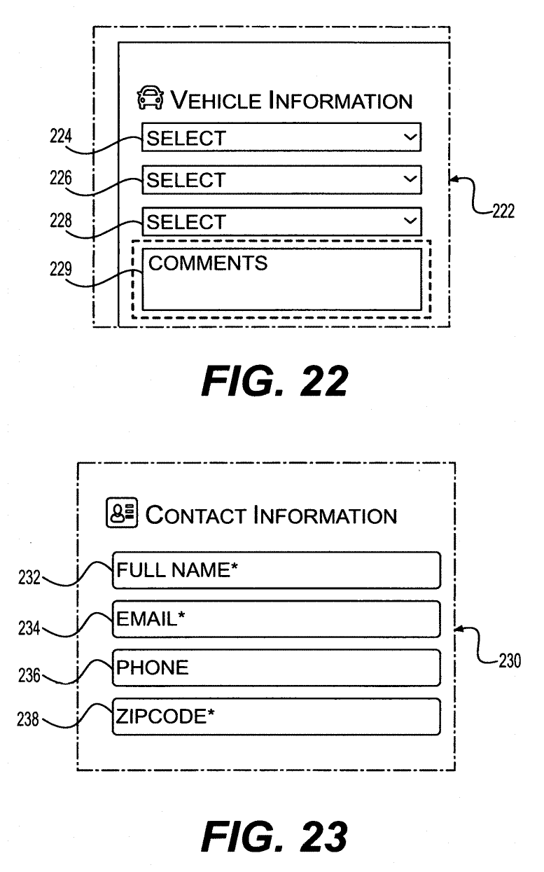

As shown in FIG. 22, the COMMENTS selection box 229 allows a user to add issues or requests regarding the servicing of the user's vehicle.

After completing the VEHICLE INFORMATION section 222, the user can then enter their contact information into the CONTACT INFORMATION section 230, as shown in FIGS. 23-27. The CONTACT INFORMATION section 230 comprises a user's FULL NAME selection box 232, a user's EMAIL selection box 234, a user's PHONE number selection box 236, and a ZIPCODE selection box 238.

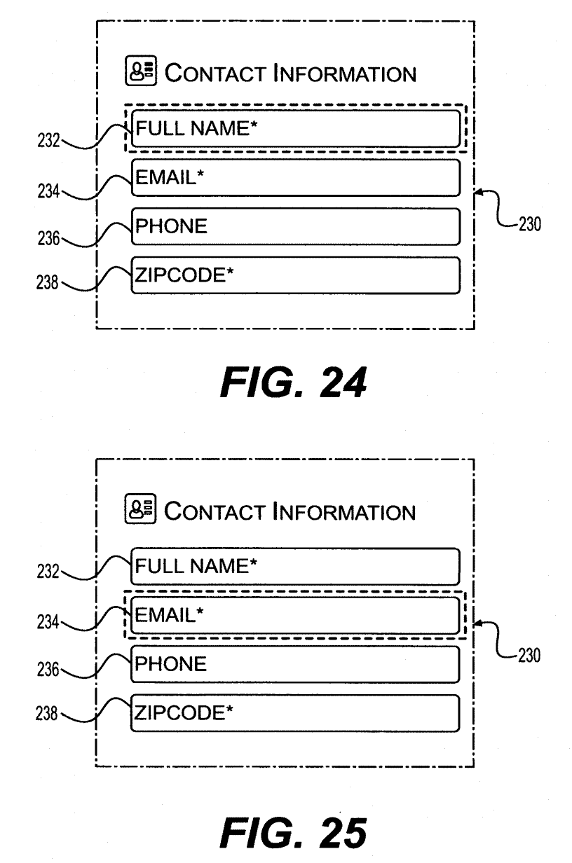

As shown in FIG. 24, the user's FULL NAME selection box 232 is mandatory and must be filled in by the user to schedule a service appointment. The FULL NAME selection box 232 requires the full name of the user to be entered. The site visitor can simply type in their name and move forward.

As shown in FIG. 25, the user's EMAIL selection box 234 is mandatory and must be filled in by the user to schedule a sales appointment. The EMAIL selection box 234 requires the valid email address of the user to be entered. The site visitor can simply type in their email address and move forward.

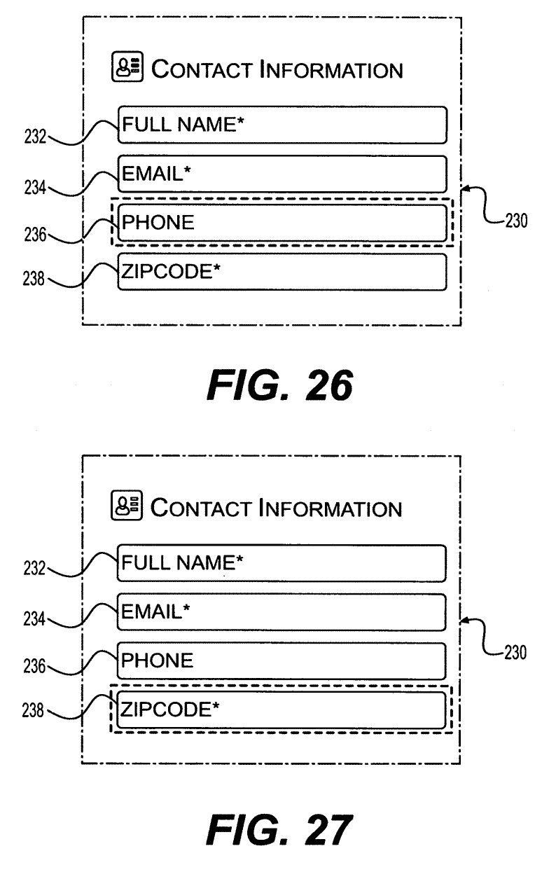

As shown in FIG. 26, the user's PHONE number selection box 236 is not mandatory, and is optionally filled in by the user to schedule a sales appointment. The PHONE number selection box 236 requires the phone number of the user to be entered. The site visitor can simply type in their digits.

As shown in FIG. 27, the ZIPCODE selection box 238 is mandatory and must be fill out by the consumer to schedule a sales appointment. The ZIPCODE selection box 238 requires the zip code of the user to be entered. The site visitor can simply type in their zip code and move forward.

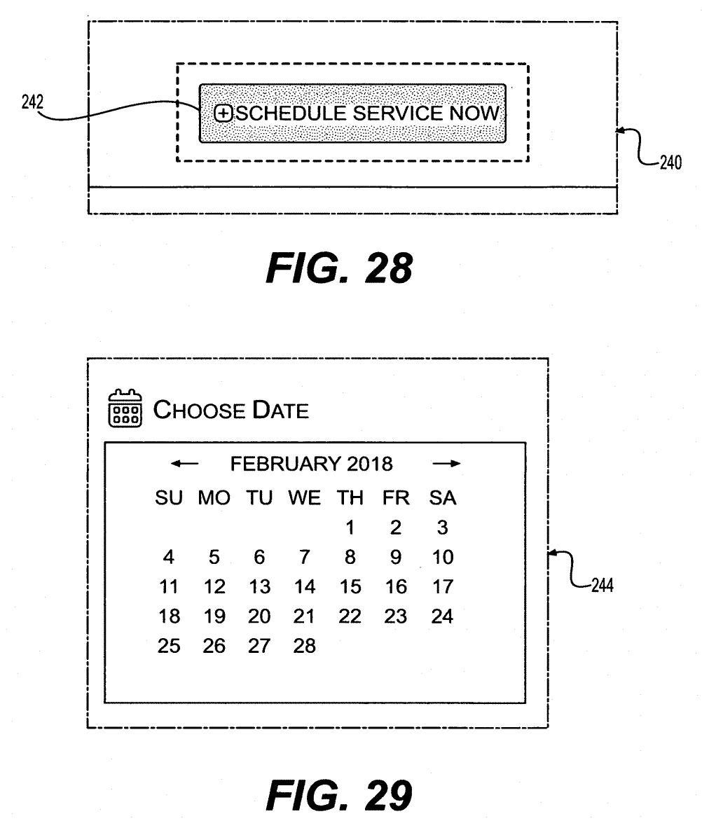

After completing the CONTACT INFORMATION section 230, the SCHEDULE SERVICE NOW button 242 is displayed in section 240, as shown in FIG. 28. Once all of the pertinent information is filled in by the user in the VEHICLE INFORMATION section 222 (FIG. 18) and the CONTACT INFORMATION section 230 (FIG. 23), then the SCHEDULE SERVICE NOW button 242 is clicked on by the user. A pop up will be displayed and inform the user that a confirmation email and/or text, if phone number entered, will be sent to the user's email provided. This step will schedule and finalize the user's service appointment.

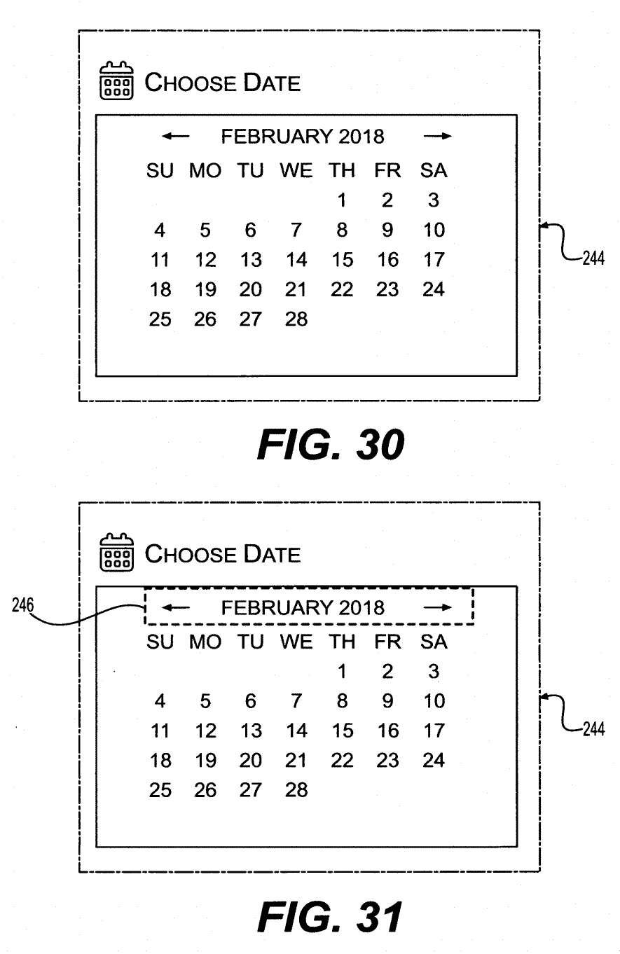

After clicking on the SCHEDULE TEST DRIVE button 242 and the confirmation is displayed, the CHOOSE DATE section 244 is then displayed, as shown in FIG. 30.

The CHOOSE DATE section 244 is shown in FIGS. 29-31. The CHOOSE DATE section 244 is where the user selects the specific date of their service appointment.

As shown in FIG. 30, the CHOOSE DATE section 244 includes a calendar to allow the user to select the date user would like to schedule their sales appointment. The calendar lists the days, including Su (Sunday) thru Sa (Saturday) across the top of the days with the particular month corresponding to the date displayed above. The user can then select from all available dates for the particular date for their sales appointment.

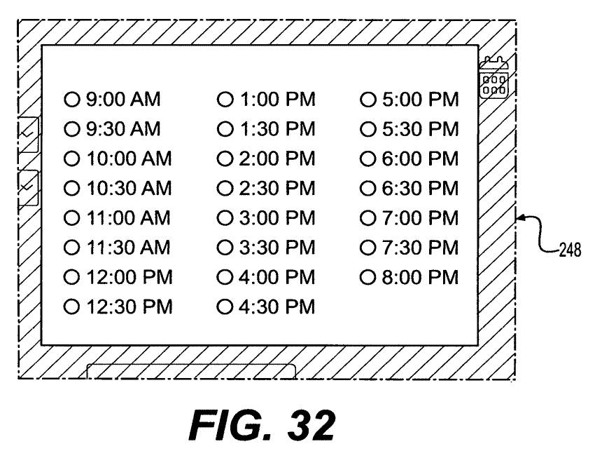

As shown in FIG. 31, the MONTH selection box 246 allows the user the ability to select the current month, past, or future month to schedule their service appointment in the calendar of the CHOOSE DATE section 244. The user's sales appointment, for example, can be selected up to 30 days in advance.

The TIME selection box 248 is shown in FIG. 16. The TIME selection box 248 pops up, for example, automatically after the user selects their date for their service appointment. The pop-up, for example, will display available time slots to be selected by the user. The time slots are available, for example, from 9:00 am-9:00 pm. The times slots, for example, will be in 30 minute intervals.

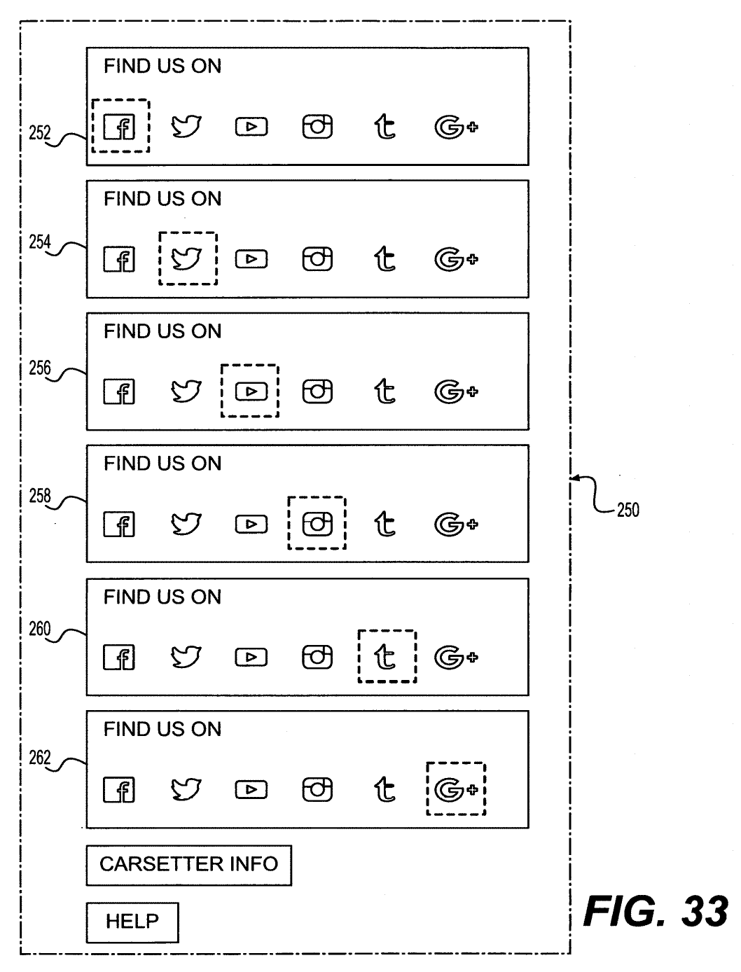

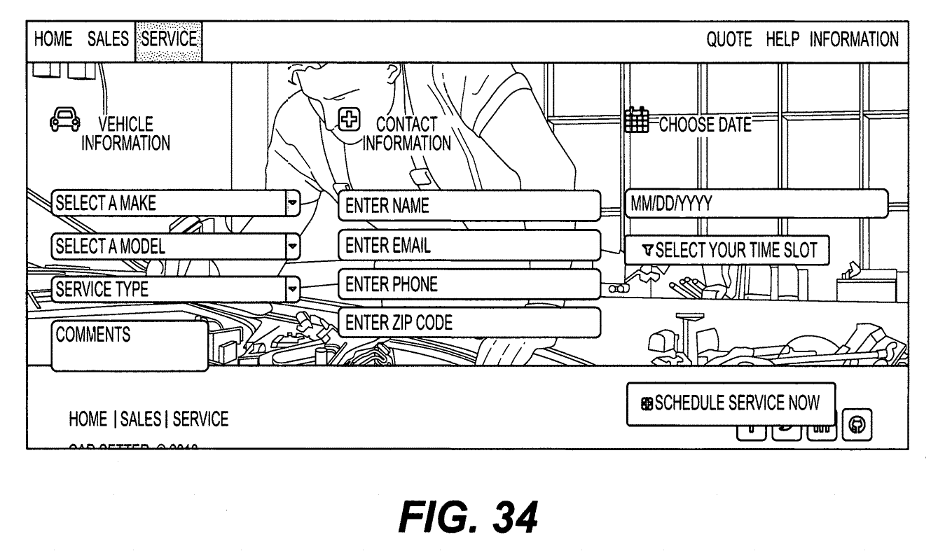

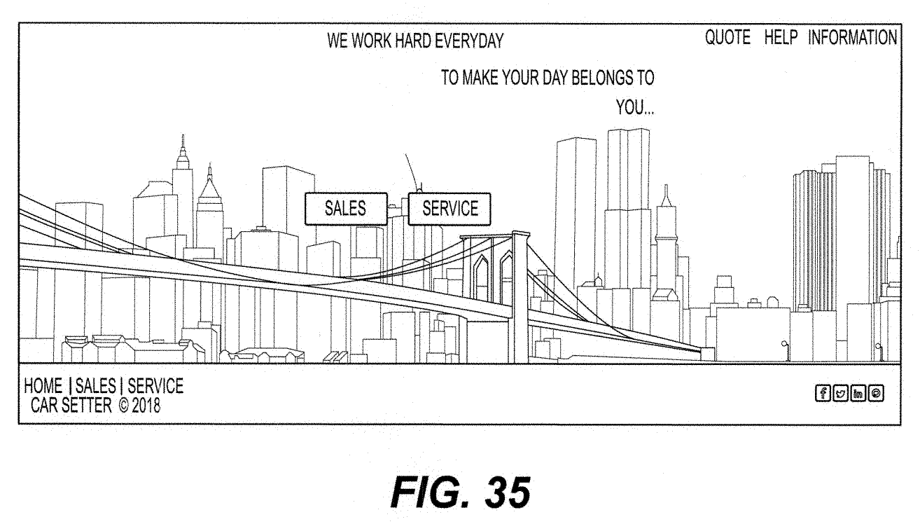

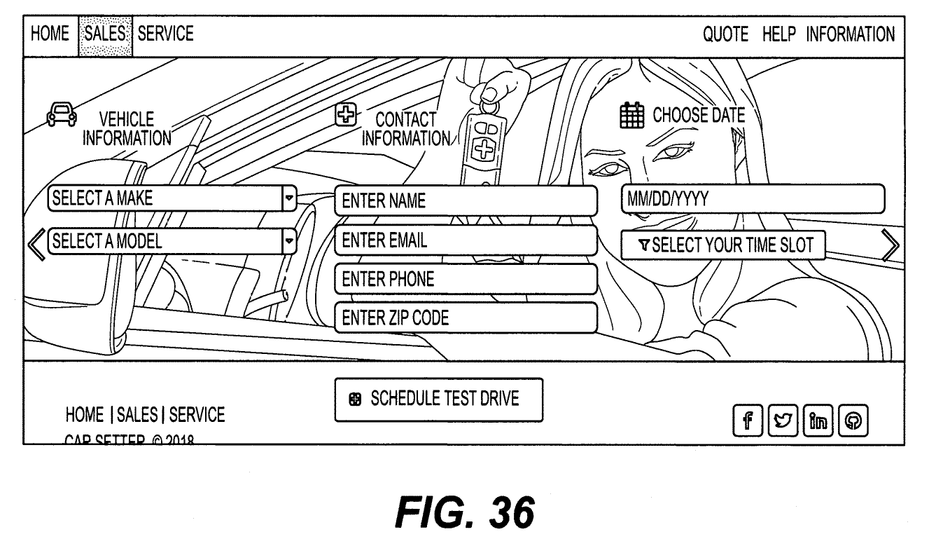

The Social Media Platform section 250 is shown in FIG. 33. This is the section of the webpage where the user can share the usage of this platform to Social Media. The Social Media Platform section 250 comprises a Facebook button 252, Twitter button 254, You Tube button 256, Instagram button 258, Tumblr button 260, and Google Plus button 262.

### Online Link

The CARSETTER™ website can include the feature of providing a link (e.g. logo, mark, or icon functioning as link) that connects the user from a dealership website to the CARSETTER™ website by clicking on the link to conveniently schedule an appointment for user (e.g. consumer). For example, a logo type link can be displayed on dealerships inventory Vehicle Display Pages (VDPs) displayed on the dealership's website. Today, most if not all dealerships display and advertise their inventory of vehicles throughout the world wide web or Internet using their own dealership website, and/or 3^{rd} party affiliated website(s). These dealership vehicles are all displayed on individual Vehicle Display Pages (VDPs) and reach each dealership's targeted market. Along with the CARSETTER™ platform, which drives the user back to their local dealership, a Vehicle Display Page (VDP) will also allow the dealership to obtain users looking at their vehicles online. Therefore, any user interested in that particular vehicle, from any area, will have the ability to schedule their appointment directly with that dealership. They would simply click the logo or icon link and the complete the appointment process described above. There would be no box to input the users zip code, as the dealerships zip code will be pre-filled. This is because the consumer is directly scheduling their appointment for that vehicle on that VDP, which belongs to the dealership that has that vehicle.

This additional feature will offer the dealership the diversification of reaching and attaining consumers from multiple areas to their dealership, along with driving local consumers who use CARSETTER™ directly to schedule their appointments. Any user that comes to the CARSETTER™ website directly and schedules their appointment will be driven to the local dealership on the network. Those users who schedule their appointments directly with the CARSETTER™ icon on the VDP's, will be driven directly to that dealership.

The reach of the VDPs will extended beyond the dealerships local area, and therefore drive conquest business to them as well. CARSETTER™ will be a total solution for dealerships to reach consumers (i.e. users) based on their vehicles visibilities and be on a network that will drive their local consumers back to them in a hassle-free manner. The consumer (i.e. user) will now have the ability to schedule their automotive appointments, quickly, efficiently and at no charge with the platform. They will also be able to schedule their appointments on the vehicles that they search online with the same type of efficiency and ease. This gives them the convenience of covering all their bases, while maintaining a hassle-free, fast efficient process that protects their information, their time and it's all at no charge.

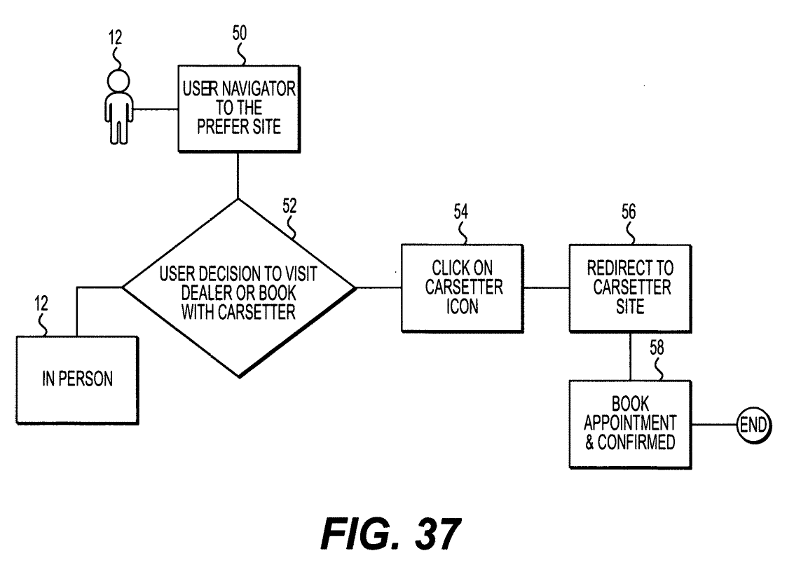

The flow diagram for a typical user 12 interested in looking at new or used vehicles for sale at a vehicle dealership is shown in FIG. 37. The user 12 goes online and navigates to a preferred site 52 (e.g. vehicle dealership website) to review information and photos on new and used vehicles in inventory at the particular vehicle dealership. The user 12 can then decide to visit the dealership in person and view and inspect the new and used vehicle inventory located at the dealership. Alternatively, the user 12 can decide to click on the CARSETTER™ logo or link shown for a particular vehicle displayed on the Vehicle Display Page (VDP). Upon clicking on the particular CARSETTER™ logo or link for a particular next to a particular vehicle of interest to the user, the user is redirected from the vehicle dealership website to the CARSETTER™ website 56, and then the user 12 books or schedules and appointment to see the selected vehicle 58. The user 12 then receives a confirmation (e.g. email, text, website) for the appointment 58, and then visits the vehicle dealership for the appointment.

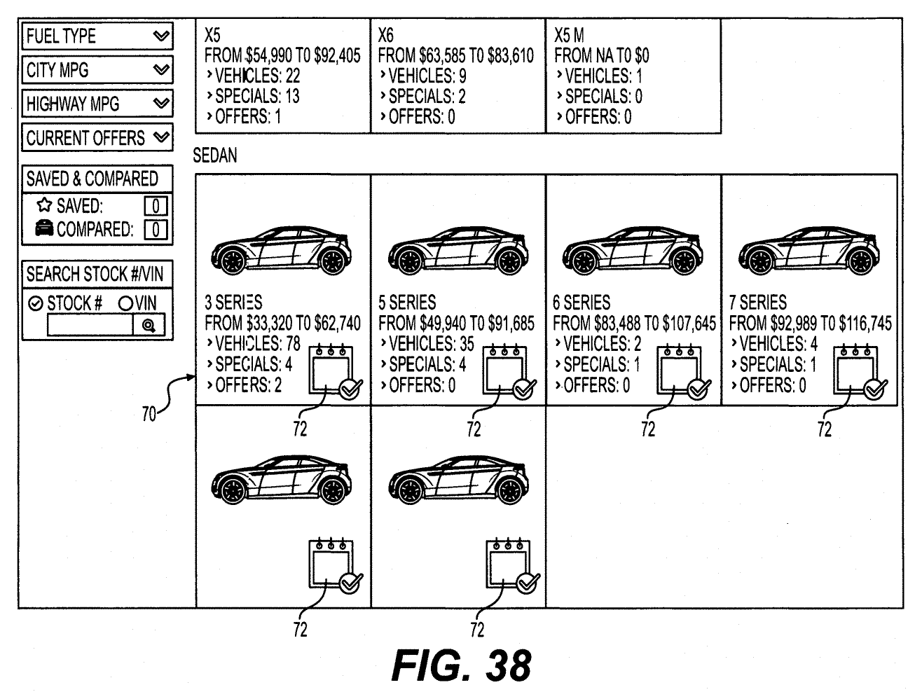

An example of a Vehicle Display Page (VDP) is shown in FIG. 38 showing, for example, colored photos and information on six (6) different autos on the particular dealership's webpage. The dealership typically provides many Vehicle Display Pages (VDPs) at the dealership's webpage. The user then clicks on the CARSETTER™ logo or link located next to the particular vehicle the user is interested in to select same. The user is then redirected to the CARSETTER™ website to schedule a sales appointment with the particular dealership having inventory of the particular vehicle of interest.

The above system and method can be applied to scheduling service appointments for vehicles. The user can go to a dealership website for a particular brand of vehicles (i.e. make) and enter the year, make, and model. One or more photos of the selected year, make and model are displayed on a Vehicle Display Page (VDP), and then the user can click on a logo or link next to the vehicle selected by the user to redirect the user to the vehicle appointment scheduling website to schedule a service appointment with the particular dealership. Alternatively, the user can go directly to the vehicle appointment scheduling website and enter the year, make, and model of their vehicle. One or more photos of the selected year, make, and model are displayed on a Vehicle Display Page (VDP), and then the user can click on a logo or link next to the vehicle selected by the user to make a service appointment with the appropriate dealership.

1. A web-based vehicle dealership appointment scheduling method comprising:
a user accessing a vehicle dealership website for viewing vehicles on a Vehicle Display Page (VDP);
the user selecting a vehicle of interest by clicking on an appointment scheduling website logo or link next the vehicle of interest;
redirecting the user from the vehicle dealership website to the appointment scheduling website; and
scheduling an appointment with the vehicle dealership website using the vehicle appointment scheduling website.

2. The method according to claim 1, wherein the user initially enters a vehicle information regarding the make and model of the vehicle of interest on the vehicle dealership website.

3. The method according to claim 1, wherein alternatively the user can go directly onto the vehicle appointment scheduling website and view vehicle inventory from multiple vehicle dealerships.

4. The method according to claim 1, wherein an operator of the vehicle appointment website selects the vehicle dealerships available on the vehicle appointment scheduling website.

5. The method according to claim 1, wherein vehicle dealerships are selected by an operator of the vehicle appointment scheduling website based on at least one range of distance from a central location of the user.

6. The method according to claim 1, wherein vehicle dealerships are selected by an operator of the vehicle appointment scheduling website based on the vehicle dealerships having a membership or affiliation with the vehicle appointment website.

7. The method according to claim 4, wherein vehicle dealerships are selected by an operator of the vehicle appointment scheduling website based on a varying fee schedule dictating priority.

8. The method according to claim 1, wherein the user enters contact information into the vehicle appointment scheduling website to arrange an appointment with the vehicle dealership.

9. The method according to claim 8, wherein the user selects an available time and date for the appointment with the vehicle dealership through the vehicle appointment scheduling website.

10. The method according to claim 1, wherein the user receives a confirmation from the vehicle appointment scheduling website after making an appointment with the vehicle dealership.

11. The method according to claim 10, wherein the vehicle dealership selected by the user clicking on the vehicle appointment scheduling website next to the vehicle of interest receives a confirmation from the vehicle appointment scheduling website.

12. The method according to claim 1, wherein the vehicle appointment scheduling website receives information on available times and dates for sales appointments from participating vehicle dealerships.

13. The method according to claim 12, wherein the available times and dates are updated continuously in real time between the participating vehicle dealership websites and the vehicle appointment scheduling website.

14. The method according to claim 3, wherein the vehicle appointment scheduling website selects the closest vehicle dealerships located to the user based on the zip code of the user and the zip code of the vehicle dealerships.

15. The method according to claim 3, wherein the vehicle appointment scheduling website selects the closest vehicle dealerships located to the user based on the address of the user and the address of the vehicle dealerships.

16. The method according to claim 3, wherein the vehicle appointment scheduling website displays to the user online a listing of multiple vehicle dealerships that can be selected by the user.

17. The method according to claim 3, wherein the vehicle appointment scheduling website displays to the user online a distance between the user's address and each of the multiple vehicle dealerships.

18. The method according to claim 3, wherein the user clicks the vehicle appointment scheduling website logo or link next to the vehicle of interest to make an appointment with the vehicle dealership having the vehicle of interest at the location of the vehicle dealership.

19. A web-based vehicle dealership appointment scheduling method comprising:
a user accessing a vehicle dealership website for viewing vehicles on a Vehicle Display Page (VDP);
the user selecting a vehicle of interest by clicking on a vehicle appointment scheduling logo or link next the vehicle of interest; and
scheduling an appointment with the vehicle dealership website using a vehicle appointment scheduling website.

20. The method according to claim 19, wherein alternatively the vehicle appointment scheduling logo or link allows the user to directly schedule an appointment with the vehicle dealership website.
